(19) United States
(12) Patent Application Publication
(10) Pub. No.: US 2011/0171595 A1
(43) Pub. Date: Jul. 14, 2011

(54) DENTAL BUR

(75) Inventors: Derek M.J. TURNER, Ottawa (CA); Kevin John BAILEY, Ottawa (CA)

(73) Assignee: TTI TURNER TECHNOLOGY INSTRUMENTS INC., Montreal (CA)

(21) Appl. No.: 12/900,746

(22) Filed: Oct. 8, 2010

Related U.S. Application Data
(60) Provisional application No. 61/250,283, filed on Oct. 9, 2009.

(30) Foreign Application Priority Data
Oct. 9, 2009 (CA) 2682534

(51) Int. Cl. A61C 3/00

(52) U.S. Cl. 433/127

(57) ABSTRACT

The invention relates to an improved bur for use in handpieces having a rotatable chuck with a tool bore for receiving the bur, a friction grip member for frictionally retaining the bur in the chuck and a torque lock seat of non-circular cross-section and permitting length adjustment of the bur in the drive head by concentrically supporting the bur in the drive head at any position from a fully inserted position to a maximum retracted position. The bur includes a tool body having an axis of rotation, a working end for projecting from the handpiece and a driven end for insertion into the tool bore of the chuck. The driven end is a generally cylindrical shaft with a preselected outer circumference for fittingly engaging in the tool bore for concentric rotation of the driven end with the chuck. The shaft including a torque lock portion for fittingly and non-rotatably engaging the torque lock seat of the chuck. The torque lock portion has at least two flat surfaces circumferentially spaced apart by intermediate cylindrical mantle portions, for providing the locking portion with a cross-section including alternating circular and straight sections and fitting into the non-circular cross-section of the torque lock seat to prevent rotation of the torque lock portion in the torque lock seat. The circular sections have the same diameter as the outer diameter of the cylindrical shaft. A total area of the flat surfaces covers at least 0.001956 square inches and the circular sections extend over at least 30% of the outer circumference of the driven end. This maintains efficient torque transfer between the chuck and the tool and ensures concentricity of the bur in the handpiece to prevent undue vibration of the bur in the handpiece.

### CROSS-REFERENCE TO RELATED APPLICATION

This application claims priority from U.S. Application Ser. No. 61/250,283, filed Oct. 9, 2009 and entitled Dental Bur, which application is included herein by reference in its entirety.

### FIELD OF THE INVENTION

The present invention relates generally to dental and medical tools and in particular to dental burs.

### BACKGROUND OF THE INVENTION

Numerous medical and dental handpieces for rotating tools exist. Turbine driven handpieces are widely used in dental offices and medical labs around the world. Most handpieces include a handle and a drive head for supporting the rotating tool. The drive head houses a tool drive, generally composed of a tool retaining mount or chuck, and a motor or turbine, rotatably mounted in the head for driving the chuck. The chuck releasably holds the tool, such as a dental bur, for rotation about an axis of rotation. The tool is releasably held by the chuck against axial movement in the drive arrangement. Various locking arrangements are known for the manual locking and releasing of the tool in and from the chuck.

Generally, dental handpieces are not designed to allow for length adjustment of the bur, which means the bur, once fully inserted in the chuck will always protrude the same length from the drive head. However, a dentist may need to use burs of different exposed length, which requires bur replacement or handpiece exchange during a procedure. In an attempt to find a time and cost efficient solution, dentists often try to adjust the protruding length of the tool by somewhat retracting it from the drive head until the desired length is reached. This adjustment is made without knowledge whether the tool will remain properly engaged within the drive mechanism and safely secured within the drive head. However, conventional handpiece designs provide for concentrical support of the tool in the fully inserted condition only. Even a minor retraction of the tool from the fully inserted position will disengage the tool from the concentrical support at the rear end of the tool, at which point the bur is maintained in axial alignment only by the flexible friction arms of the chuck. This can result in a loss of concentricity, or vibration of the bur during rotation, which can lead to excessive wear of the bur and damage to the drive, or components thereof. Such damage may cause inefficient torque transfer, increased bur slippage (both rotational and axial), and most dangerously, accidental disengagement of the bur from the handpiece during use.

Commonly owned copending application PCT CA2006/000954 discloses a handpiece design allowing for tool depth adjustment without a loss of concentricity. Tools with a non-circular torque lock portion allowing insertion length adjustment and including a retraction depth indicator in the torque lock portion are also disclosed.

Different tools require different torque to rotate and cut effectively. The required torque also depends on the material to be cut. Although the torque output of air turbine drives in medical or dental handpieces is limited, much higher torque output can be achieved with electric motor driven handpieces. Electrical handpieces can produce torque which can be 10 times as high as that of an air turbine driven handpiece. The torque lock portion on previously known burs may be subject to damage at elevated torque if the area available for torque transfer is too small to support the angular forces produced.

### SUMMARY OF THE INVENTION

It is an object of the present invention to obviate or mitigate at least one disadvantage of prior art bur designs.

Through extensive research, the present applicants have now discovered that for reliable torque transmission at minimum damage to the bur and chuck over time, strict dimensional requirements must be followed for the construction of the tool and especially the torque lock portion of the tool. In particular, the present applicants have discovered that making the contact area available for torque transfer as large as possible, which would appear logical in order to avoid damage to the torque lock portion by angular forces, does not necessarily prevent damage to the torque lock section. The present applicants have surprisingly discovered that damage to the torque lock portion can also be caused by vibration of the tool in the drive arrangement and that such vibrations can also reduce cutting accuracy and performance.

In a first aspect, the invention provides a bur for use in a handpiece with a drive head and a chuck, permitting length adjustment of the bur in the drive head by concentrically supporting a driven end of the bur in the drive head at any position from a fully inserted position to a maximum retracted position.

In an embodiment, the bur includes a tool body having an axis of rotation, the tool body being divided into a driven portion with a driven end for insertion into the drive head and a working portion for projection from the drive head during use. At the driven end, the bur further includes a torque lock portion in the form of a non-circular shaft portion for engagement of a non-cylindrical torque lock seat of the chuck. The driven portion has a generally cylindrical shape with an outer circumference and an axial length. The torque lock portion at the driven end of the driven portion can be fully inserted into the torque lock seat or retracted from the fully inserted position up to a maximum retraction position in which a terminal portion of the torque lock portion is engaged in the torque lock seat, while the remainder of the torque lock portion is outside the torque lock seat.

Applicants have now discovered that careful balancing of the torque transmission requirements with the tool centering requirements is essential to proper operation, functioning and safety of the handpiece and tool combination. In the torque lock portion, the tool shaft includes alternating cylindrical mantle portions and flat surfaces, the flat surfaces having been cut into the cylindrical shaft exterior. The torque lock portion therefore includes flat surfaces (flats) and adjacent round surfaces in the form of cylindrical mantle sections (rounds), which flats and rounds are circumferentially evenly spaced. Furthermore, applicants have surprisingly discovered that the determining factor for reliable torque transfer and for preventing torque damage is the total contact area between the flats and the chuck. Torque is transferred by way of the flats, while centering of the tool in the drive arrangement is achieved with the rounds. The present applicants have further discovered that the determining factor for preventing vibration damage to the bur is the total area of the rounds on the terminal part of the torque lock section. The smaller the angle covered by each round and the lower the number of rounds in the torque section, the less reliable the fit of the tool in the torque lock seat of the drive arrangement and the higher the risk of vibration of the tool in the socket. In order to ensure reliable torque transmission when the maximum retraction depth of the bur is reached without undue damage to the torque lock section, the flats in the terminal portion must cover a minimum combined area of 0.001956 sq in, while in order to prevent undue vibration of the tool in the torque lock seat, the rounds in the terminal portion must cover at a minimum 30% of the shaft exterior in the terminal portion. Additionally, the ratio of flats to rounds on the tool must fall within a specific range for reliable torque transmission. Each flat extends over a first circumferential angle of the tool and each round extends over a second circumferential angle of the tool. Irrespective of the diameter of the tool, the ratio of the sum of the first angles to the sum of the second angles is preferably within the range of ⅙ to ¾.

A tool in accordance with the invention may include indexing grooves in the rounds of the torque lock section, which are intended to interact with the friction grip arms of the drive arrangement to provide the user a tactile indication, possibly even an auditory indication (click), that the maximum retraction depth has been reached. If the angle covered by each round is too small, the groove in the round is too short for a reliable mechanical engagement with the friction grip arms of the chuck. In order to ensure sufficient groove length for reliable engagement between the friction arms and the groove, and reliable axial retention of the tool in the chuck, the ratio of the total angle covered by the flats to the total angle covered by the rounds should be 40/60 to 60/40.

In one embodiment, the dental bur in accordance with the invention for use in a dental handpiece having spaced apart front and rear bur supports for rotatably supporting the bur and an intermediate friction grip for releasably retaining the bur in the handpiece, the rear bur support being axially elongated to support the bur at different insertion depths from a maximum insertion depth at which the bur is fully inserted into the handpiece to a maximum retraction depth at which the bur is maximally retracted from the rear support, without disengaging from the rear support, the rear support forming a torque lock seat of non-circular cross-section, includes a tool body having an axis of rotation, the tool body having a driven portion for insertion into the handpiece and a working portion for projecting from the handpiece during use, the driven portion having a generally cylindrical shape and a torque lock portion for fitting insertion into the rear support at the different insertion depths; the torque lock portion having an outer circumference for fittingly engaging in the rear support for concentric rotation of the driven end with the rear support, the torque lock portion having at least two planar mantle portions circumferentially spaced apart by intermediate cylindrical mantle portions, for providing the locking portion with a cross-section including alternating circular and straight sections and fitting into the non-circular cross-section of the torque lock seat to prevent rotation of the torque lock portion in the torque lock seat, the circular sections having the same diameter as the outer diameter of the cylindrical shaft, a total area of the planar mantle portions engaged in the rear support when the bur is in the maximum retraction position covering at least 0.001956 square inches, the circular sections extending over at least 30% of the outer circumference of the driven end and a ratio of the total circumferential angle covered by the planar mantle portions to the total circumferential angle covered by the cylindrical mantle portions being within the range of ⅙ to ¾.

In another embodiment, the bur further includes a maximum retraction indicator on the driven portion for mechanical engagement with the friction grip of the handpiece for indicating when the bur is retracted from the rear support to the maximum retraction depth to prevent further retraction and disengagement of the driven end from the rear seat.

The maximum retraction indicator is preferably located on the torque lock portion of the bur and is most preferably an annular groove extending circumferentially about the torque lock section and across each of the cylindrical mantle portions, each planar mantle portion extending over a first circumferential angle of the tool and each cylindrical mantle portion extending over a second circumferential angle of the tool, with a ratio of the sum of the first angles to the sum of the second angles being 2/3 to 3/2.

The torque lock portion of the shaft preferably includes at least 3 cylindrical mantle portions and a plane of the planar mantle portions is oriented parallel to the axis of rotation and preferably also perpendicular to a radius of the shaft. The cylindrical and planar mantle portions are preferably circumferentially evenly distributed.

In a further embodiment, a bur in accordance with the invention for use in a dental or medical handpiece having a rotatable chuck with a tool bore for receiving the bur, a friction grip member for frictionally retaining the bur in the chuck and a torque lock seat of non-circular cross-section, includes a tool body having an axis of rotation, a working end for projecting from the handpiece and a driven end for insertion into the tool bore of the chuck, the driven end being a generally cylindrical shaft with a preselected outer circumference for fittingly engaging in the tool bore for concentric rotation of the driven end with the chuck, the shaft including a torque lock portion for fittingly and non-rotatably engaging the torque lock seat of the chuck, the torque lock portion having at least two flat surfaces circumferentially spaced apart by intermediate cylindrical mantle portions, for providing the locking portion with a cross-section including alternating circular and straight sections and fitting into the non-circular cross-section of the torque lock seat to prevent rotation of the torque lock portion in the torque lock seat, the circular sections having the same diameter as the outer diameter of the cylindrical shaft, a total area of the flat surfaces covering at least 0.001956 square inches and the circular sections extending over at least 30% of the outer circumference of the driven end.

The locking portion preferably further includes a mechanical stop for mechanical engagement with the grip member.

The torque lock portion is preferably axially elongated to allow positioning of the bur in the tool bore at any location from a maximum insertion position wherein the driven end is fully inserted into the chuck to a maximum retraction position wherein only a terminal part of the driven end remains inserted in the chuck but still concentrically supported in the tool bore, the mechanical stop being positioned on the torque lock portion for engagement with the grip member when the tool is in the maximum retraction position and a total area of the flat surfaces on the terminal part covering at least 0.001956 square inches.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a cross-sectional view of a known dental handpiece suitable for use with a tool in accordance with an embodiment of the invention;

FIG. 2 illustrates a tool drive arrangement having a spindle and an asymmetrical chuck, in combination with a bur in accordance with the invention;

FIG. 3 is a perspective view of a bur in accordance with the invention;

FIGS. 4A and 4B illustrate axial cross-sections through the drive arrangement of FIG. 2 in an assembled condition with FIG. 4B rotated 90° about the axis of rotation relative to FIG. 4A;

FIG. 5 illustrates an axial cross-section through the drive arrangement as shown in FIG. 4A, with a bur as shown in FIG. 3 inserted into the spindle;

FIG. 6 illustrates a perspective view of a bur with maximum area of flats;

FIG. 7 is a perspective view of a bur with an insufficient area of flats;

FIG. 8 illustrates a cross-section through a bur as shown in FIG. 6 inserted into the chuck shown in FIG. 2;

FIG. 9 illustrates a cross-section through a bur as shown in FIG. 7 inserted into the chuck shown in FIG. 2; and

FIG. 10 illustrates a cross-section through a preferred bur in accordance with the invention inserted into the chuck shown in FIG. 2.

### DETAILED DESCRIPTION OF THE PREFERRED EMBODIMENTS

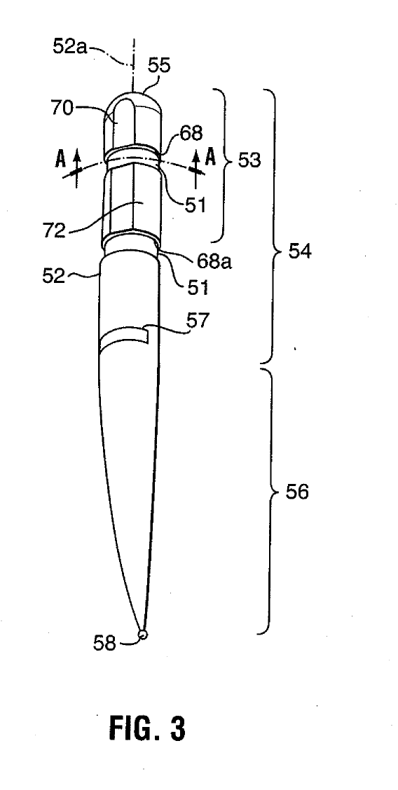

Generally, the present invention provides a bur for a dental or medical handpiece having a rotatable chuck with a tool bore for receiving the bur, a friction grip member for frictionally retaining the bur in the chuck and a torque lock seat of non-circular cross-section. As shown in FIGS. 3, 8 and 9, the bur has a tool body 52 having an axis of rotation 52a and is divided into a generally cylindrical, driven portion 54, with a driven end 55 for insertion into the chuck, and a working portion 56 for projecting from the drive head during use. At the driven end 55, the bur includes a non-round torque lock portion with alternating flat sections 70 cut into the cylindrical shaft of the bur and round sections 72 in which the exterior surface of the shaft remains intact. At least three flat sections 70 are preferably included.

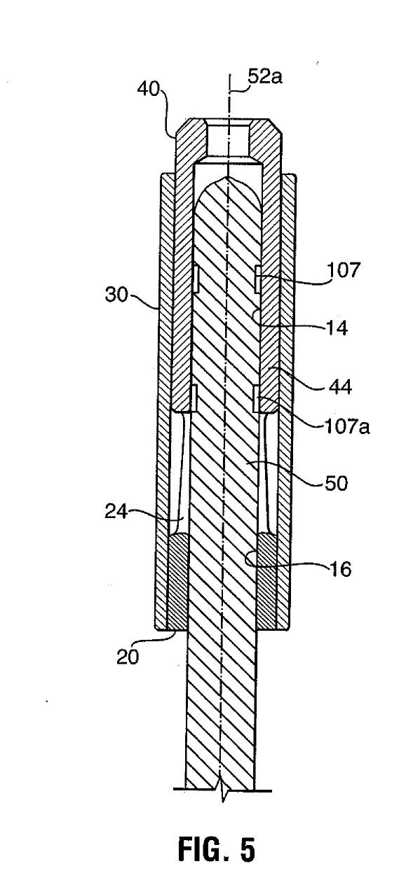

When the handpiece includes a bur drive arrangement permitting length adjustment of the bur in the drive head by concentrically supporting the bur in the drive head at any position from a fully inserted position to a maximum retracted position, the torque lock portion is insertable into the torque lock seat of the chuck at different depths from a fully inserted depth, at which the whole length of the torque lock portion is inserted into the torque lock seat (see FIG. 5), to a minimum insertion depth at which only a terminal part of the torque lock portion extends into the torque lock seat.

A bur in accordance with an embodiment of the invention as shown in FIGS. 3, 8 and 9 is cut with flats 70 and may also include grooves 107 for interaction with the retaining arms of the chuck. As the area of the flat faces 70 increase, it takes away more of the bur diameter. This fundamentally affects the performance of the bur and its ability to carry several orientations of loads (axial, radial, transverse) and withstand this aggressive environment of use. There is a required minimum remaining circumference acting as a sleeve support to hold the bur concentric under radial side loads and to prevent undue vibration of the bur in the chuck. However, there also needs to be sufficient original circumference left in the rounds 72 so that any grooves (51, 107) cut thereinto are sufficiently long so that the engagement force between the groove and the friction grip is sufficient to prevent axial displacement of the bur upon axial load on the bur during use.

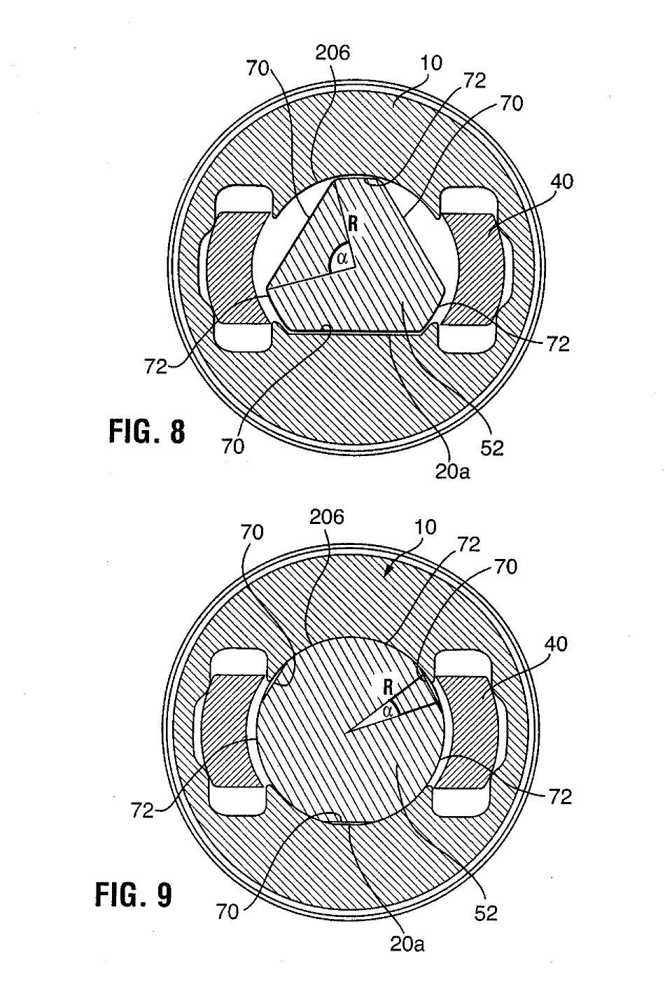

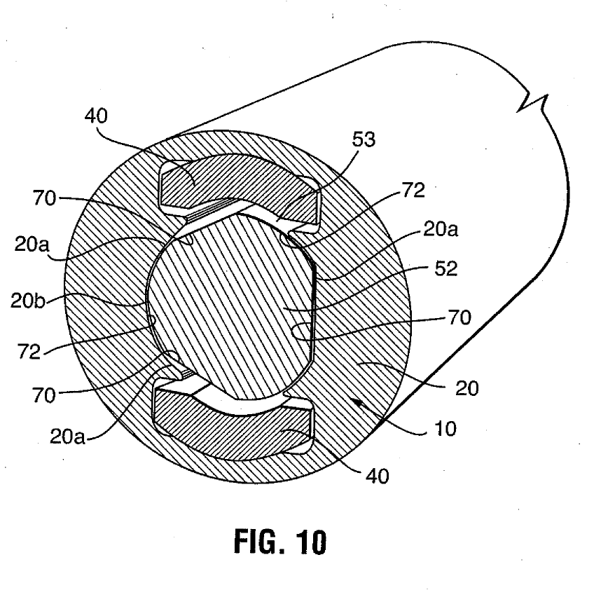

In an embodiment wherein the chuck 20 includes an asymmetrical locking socket, as shown in FIGS. 8, 9 and 10, the portion chuck 20 forming the locking socket 27 for torque transfer to the bur 50 has an asymmetrical shape to always align the bur in the socket in the same orientation relative to the sleeve. In particular, the cross-sectional shape of the socket 27 includes a flat portion 20a for engagement with one of the flats 70 on the locking portion 53 of the bur 50, which flat portion 20a is diametrically opposite a circular portion 20b of sufficient diameter to fittingly engage a externally circular section or round 72 of the locking portion 53. The spacing of the diametrically opposite flat and circular portions 20a, 20b of the locking socket 27 in the chuck 20 is selected to be substantially equal to the dimensions of the locking portion 53 of the bur 50 so that the locking portion is fittingly received in the locking socket and locked against rotation therein for reliable torque transfer from the chuck 20 to the bur 50. The asymmetrical shape of the locking socket 27 always forces the bur 50 into the same rotational position relative to the chuck 20, which significantly reduces wear.

Maximizing bur flat area would be logical in order to maximize the amount of torque which can be reliably transmitted by the torque lock section without damage to the bur. However, concentricity of the bur during lateral loads suffers, if too much of the original shaft circumference is cut away for the flats 70 (see FIG. 8). If the remaining outer surface of the shaft, which is engaged in the locking socket 27 of the chuck 20 is too small to withstand the lateral loads without vibration of the driven end 55 in the chuck, or if reliable engagement of all rounds 72 with the rounds 20b in the locking socket 27 is no longer guaranteed, vibration damage to the torque lock section 53 can occur. Thus, a proper balance of the areas of flats 70 and rounds 72 must be achieved for reliable torque transfer without undue vibration of the bur 50 in the chuck.

Maximizing the area of the bur rounds 72 may ensure a vibration free operation of the bur 50, but may result in insufficient torque transfer and damage to the bur 50 or the locking socket 27 in the areas of the bur flats 70 or the cooperating flat 20a of the locking socket (FIG. 9). Thus, a proper balancing of the areas of the flats 70 and rounds 72 on the bur 50 is required.

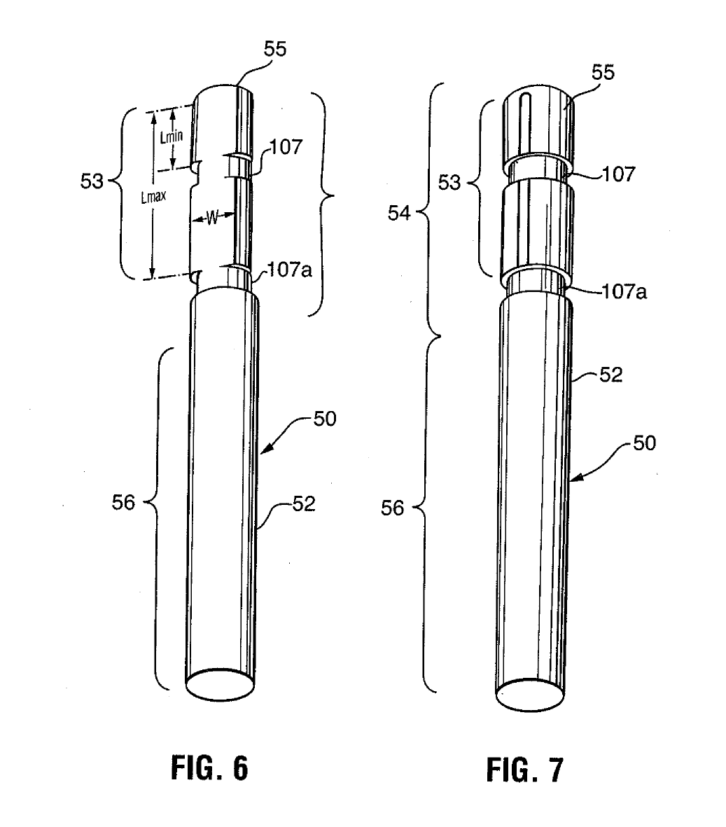

Bur flat area can be as little as 30% and as much as 70% of the total circumference of the shaft. Dental burs have a diameter that is regulated at D=0.06299 inches. Each flat 70 on the bur 50 covers a certain radial angle α and has a selected axial length L (see FIGS. 6, 8, 9). In a preferred embodiment, the axial length of the flats is L=0.09 inches. The width W of each flat 70 is determined by the circumferential angle α covered by the flat 70 and the radius R of the bur 50 and can be calculated as W=R (sin α/2) or W=½D(sin α/2). The contact area of one flat on the bur is then A=2W(L) and the total area for 3 flats is A=6W(L), which is the same as total contact area of the flats 70 with the drive. The angle α covered by a flat 70 controls the width W of the flat 70 on the bur 50 and in the matching chuck 20. The minimum practical angle X is 20 degrees and the maximum practical angle X is 80 degrees (preferred is an angle of 43 degrees). Above and below these angles, a driven portion 53 strong enough to maintain torque transfer may not be achievable.

The bur 50 can have more or fewer flats 70. In one embodiment, each flat 70 on the bur 50 extends over an angle X of about 50°, with the total angle of the three flats being 151° or 42% of the bur circumference, leaving 58% of the outer circumference of the cylindrical shaft portion intact, which means the rounds cover 58% of the circumference.

The contact area between the bur 50 and the chuck 20 in the torque lock portion 53 of the bur 50 depends on the number of flats 70, the width W of the flats and the insertion depth L of the torque lock section 53 of the bur 50 into the torque lock seat of the chuck 20. The present applicants have discovered that the key indicators for reliable torque transfer are the total area of the flats 70 which is in engagement with the torque lock seat of the chuck and used for torque transmission (and the circumferential angle X of each flat 70). The minimum area of flats required was determined to be Ad=0.001956 sq inch. That means that when the bur is used in a handpiece allowing for length adjustment of the bur, this minimum area of flats must be in engagement with the chuck 20 when the bur is at the maximum retraction position. In other words, the minimum area of flats on the terminal part of the torque lock portion 53 must be Ad=0.001956 sq inch if the bur 50 is to be reliably driven in the maximum retraction position without undue torque damage.

A reduction in the drive area Ad happens as the torque lock portion 53 on the bur 50 is interrupted by latching or retraction indicator grooves (51,107), which again reduce the actual area available for the torque transfer. Furthermore, the total available drive area of the flats 70, which is in engagement with the torque lock seat, is further reduced when the bur 50 is in a retracted position. In order to ensure reliable torque transfer at the maximum retracted position, the area of engagement between the flats 70 and the chuck 20, irrespective of the number of flats on the bur, must be sufficient to prevent torque damage to the bur 50.

Through extensive research, the present applicants have discovered that the principle determining factors in preventing torque damage to the bur are the circumferential angle X covered by each flat 70 the total surface area on the bur which is used for torque transmission, irrespective of the shape of the torque lock section, or the shape of the surface used for torque transmission. Flats which are too narrow can, such as those shown in FIGS. 7 and 9, become easily rounded at their lateral edges at standard manufacturing tolerances for dental burs. Moreover, if the area is insufficient to ensure reliable torque transfer, deformation of the flats 70 can result. Therefore, each flat on the bur should cover a circumferential angle X of at least 30°, preferably 35°, more preferably 38°, most preferably 38-45°. In a preferred embodiment, the angle X is 42°. Furthermore, in order to reliably prevent torque damage to the bur, the total surface area on the bur used for torque transmission must be a minimum of 0.001956 sq inches. Thus, where the torque lock section of the bur includes alternating flats and rounds, the flats being used for torque transmission, the minimum area of the flats used for torque transmission must be 0.001956 sq inches. If the bur is used in fully inserted and retracted positions, the minimum area of the flats on the part of the torque lock section which is still engaged with the chuck for torque transfer when the bur is in the maximum retraction position must be a minimum of 0.001956 sq inches. Moreover, the present applicants discovered that in order to reliably prevent undue vibration of the bur in the chuck, the area of the outer circumference of the bur shaft which remains uncut by flats or grooves and which is in fitting engagement with the tool seat during use of the bur must cover a minimum of 25% of the outer circumference. Of course, these minimum requirements are based on very tight bur-to-seat tolerances and torque damage and/or vibration may still be observed at these minimum requirements for larger tolerances. Preferably, the total surface area on the bur used for torque transmission is a minimum of 0.001956 sq inches, in order to avoid torque damage at larger tolerances and the area of the outer circumference of the bur shaft which remains uncut by flats or grooves and which is in fitting engagement with the tool seat during use of the bur preferably covers a minimum of 35% of the outer circumference for longer tolerances.

A representative sampling of exemplary burs and their respective torque damage or vibration potential are listed in Table I below (bur diameter D=0.06299 inches; 3 flats, 3 rounds; axial length of flats Lₘₐₓ=0.090 in; max insertion depth Dₘₐₓ=0.069 in; min insertion depth Dₘᵢₙ=0.040 in; Adₘₐₓ=area for torque transfer at max insertion depth; Adₘᵢₙ=area for torque transfer at minimum insertion depth Lₘᵢₙ).

TABLE I

| | | | | Torque | Torque | |
|---|---|---|---|---|---|---|
| Bur | α | Adₘₐₓ | Adₘᵢₙ | damage | damage | Vibra- |
| # | degrees | in² | in² | @ Adₘₐₓ | @ Adₘᵢₙ | tion |
| 1 | 15 | 0.001702 | 0.000987 | yes | yes | no |
| 2 | 20 | 0.002264 | 0.001313 | some | yes | no |
| 3 | 25 | 0.002822 | 0.001636 | minimal | some | no |
| 4 | 30 | 0.003375 | 0.001956 | no | minimal | no |
| 5 | 40 | 0.004460 | 0.002585 | no | no | no |
| 6 | 50 | 0.005510 | 0.003194 | no | no | no |
| 7 | 70 | 0.007479 | 0.004336 | no | no | minimal |
| 8 | 80 | 0.008381 | 0.004859 | no | no | some |
| 9 | 90 | 0.009220 | 0.005345 | no | no | yes |
| 10 | 95 | 0.009613 | 0.005573 | no | no | yes |

In a preferred embodiment, the total length of the flats insertable into the torque lock seat is Lₘₐₓ=0.069 inches and the total length of the flats still inserted into the torque lock seat in the maximum retraction position of the bur is Lₘᵢₙ=0.040. At a flats angle α=20 degrees, the total area of the flats is Ad=3RLₘₐₓ(sin 10)=0.002264 sq inch. In the fully inserted condition of the bur, the contact area between bur and chuck equals this total flats area. In any retracted position, the contact area is smaller. In the maximum retracted position, the total area of the flats available for torque transmission is Ad=3RLₘᵢₙ(sin 10)=0.001313 sq inch. This area is insufficient for reliable torque transmission without undue damage to the bur. The preferred minimum area of the flats is 0.001956 sq inches in order to ensure reliable torque transmission without undue damages to the bur even at larger manufacturing tolerances.

In the preferred embodiment, each flat covers an angle α of 40-45 degrees, preferably 42-43 degrees, most preferably about 42 degrees. At a flat angle of 42 degrees, the total area of the flats is Ad=0.002709 sq inch at the maximum retraction position. At the maximum flat angle of 80 degrees, the total flats area is Ad=0.008381 sq inch with the bur fully inserted and Ad=0.004859 sq inch at the maximum retraction position.

In one embodiment, the invention provides a bur with a maximum retraction indicator for indicating to a user when the tool has been retracted to the maximum retraction position.

The invention will now be described in more detail with reference to specific preferred embodiments of the invention directed to an improved bur. Although specific reference is made in the following to a dental bur and a drive spindle for a high speed dental handpiece, it will become apparent to those skilled in the art that all structural and functional features of the invention are equally applicable to rotatable dental and medical tools in general.

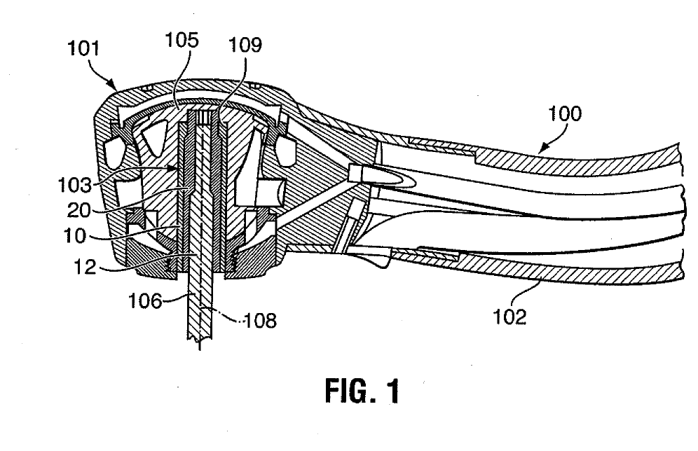

A dental handpiece 100, as shown in FIG. 1 generally includes a handle 102, a tool supporting drive head 101, and a swivel connector (not illustrated) for connecting the handpiece to various air, water, light and power supply conduits, generally combined in a so called umbilical cord (not shown). The drive head 101 includes a torque producing drive 105, typically a motor or turbine rotatably mounted in the drive head, and having a spindle socket 109 for housing a tool supporting element 103, here a drive spindle 10. The tool supporting element 103 typically includes a tool receiving and retaining portion, here a chuck 20, constructed to releasably retain a tool 106, such as a dental bur, for rotation about an axis of rotation 108. The tool supporting element 103 may be retained in the drive head 101 by any means known in the art, for example, by press-fitting the tool supporting element 103 in the spindle socket 109 of the drive head.

Referring now to FIGS. 1 to 3 and 6 to 10, a tool 106, such as the dental bur 50, typically has an elongated body 52 divided into a generally cylindrical driven portion 54 for insertion into the drive head 101 of a dental handpiece 100 for receiving drive torque from the drive 105 of the handpiece, and a working portion 56 for projecting from the drive head 101 of the handpiece in an operating condition. The working portion has a working end 58 for engagement with a working surface, such as a tooth surface (not illustrated), during a dental procedure. The user, typically a dentist, must purchase a collection of burs varying in shaft length as well as in the structure of the working end 58 of the working portion 56. The dental bur 50 is generally inserted into the spindle 10 in the drive head 101 and is removably supported therein by the chuck 20 for rotation with the spindle 10 about the axis of rotation 108.

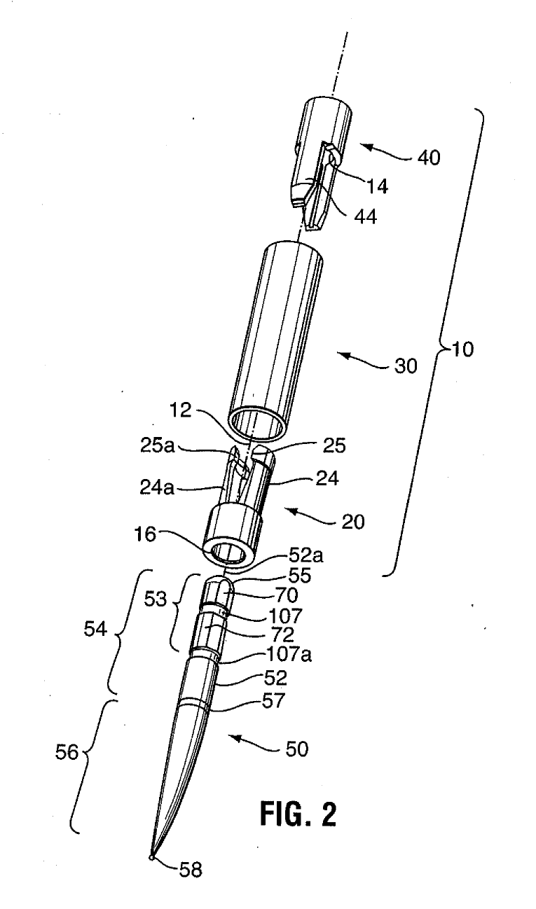

As illustrated in FIGS. 2, 8 and 9, a preferred embodiment of the dental bur 50 in accordance with the invention, includes a body 52 having an axis of rotation 52a, a working portion 56 for projecting from the drive head 101 (see FIG. 1) of a dental handpiece 100 during use, and a driven portion 54 for insertion into the drive head for directly or indirectly receiving drive torque. The illustrated bur includes a maximum retraction indicator 107, which is a mechanical indicator 59 as shown in the bur of FIGS. 2 and 3.

In a preferred embodiment as shown in FIG. 2, the mechanical type maximum retraction indicator is a groove 107 located on the driven portion 54 for axial engagement by the tool engaging tab 25 of the chuck 20 for indicating the minimum insertion depth (Dₘᵢₙ) (or maximum retraction depth) of the bur 50 in the drive spindle 10. Dₘᵢₙ is essentially the depth at which the working portion 56 is maximally extended from the handpiece while the driven portion 54 is still concentrically supported in the drive spindle 10 and properly engaged with the drive mechanism in the handpiece for reliable torque transfer. The difference between Dₘᵢₙ and Dₘₐₓ provides a length of axial play along which the bur 50 can be safely adjusted in the drive spindle 10.

As illustrated in the preferred embodiment shown in FIGS. 2, 3, 8 and 9, a second retraction depth indicator 107a can be provided on the driven portion 54 for defining a corresponding second or intermediate insertion depth of the driven portion 54 in the drive spindle 10 between Dₘᵢₙ and Dₘₐₓ, and including Dₘₐₓ or for identifying full insertion (Dₘₐₓ). The preferred embodiment illustrated in FIG. 3 shows two annular circumferential grooves 51 on the driven portion 54, those being the maximum retraction depth indicator 59 and an maximum insertion depth indicator 59a, having first and second stop shoulders 68 and 68a respectively for axial engagement with the tool engaging tab 25 upon retraction of the driven portion 54 from the maximum insertion depth toward the maximum insertion depth, Dₘᵢₙ. Axial engagement of the first axial stop shoulder 68 by the tool engaging tab 25 indicates that Dₘᵢₙ is reached. In the variant shown in FIG. 3, axial engagement of the second stop shoulder 68a by the tool engaging member 15 occurs when the tool is inserted to essentially Dₘₐₓ. The second stop shoulder 68a thus serves to retain the driven portion 54 at Dₘₐₓ during operation of the handpiece, while the first stop shoulder 68 serves to retain the driven portion 54 at Dₘᵢₙ during operation with a maximally extended bur 50.

The terms “maximum retraction indicator”, “maximum retraction depth indicator”, “minimum insertion depth indicator”, “minimum tool insertion depth indicator”, and similar terms, are used interchangeably herein. Similarly, the terms “maximum retraction position”, “maximum retraction length”, “maximum retraction depth”, “minimum insertion depth”, and similar terms, are used interchangeably herein. In this context, the terms “retracted” or “retraction” indicate that the tool is retracted from the maximum insertion depth, at which depth the tool is fully inserted into the drive spindle, toward the working end of the drive spindle. In contrast, the terms “inserted” or “insertion” refer to insertion of the tool into the working end of the drive spindle toward the driven end of the spindle.

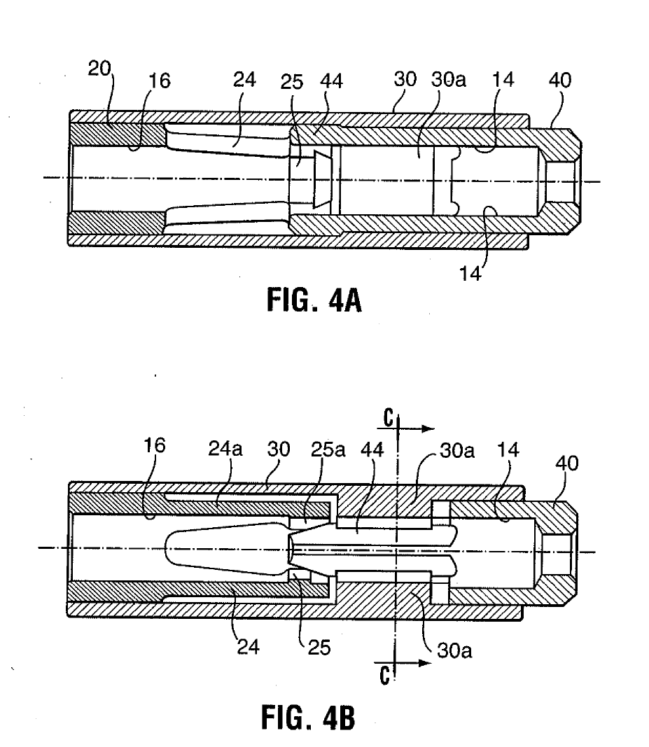

The spindle 10 of the preferred embodiment of the tool supporting element shown in FIGS. 2, 4A and 4B includes a torque receiving element in the form of a generally cylindrical casing sleeve 30 which fits into the spindle socket 109 of the drive head 101 for receiving rotational torque from the drive 105. The casing sleeve 30 houses a tool supporting element, in the form of a chuck 20, for releasably supporting the bur 50, and a ram 40 for selectively releasing the bur 50 from the chuck 20. The chuck 20 includes the tool passage 12 in the form of a tool receiving axial bore 22 for receiving the driven portion 54 of the bur 50 coaxial with the axis of rotation 108. The axial bore preferably extends from a driven chuck end 21 of the chuck 20 to the tool receiving end 23. The chuck 20 further includes a tool retaining member in the form of a resilient tool retaining arm 24. The tool passage 12 includes the first tool seat 14 for supporting the driven end 55 of the bur 50 and the second tool seat 16 for supporting the driven portion 54 at a location intermediate the driven end 55 and the working portion 56. In the embodiment exemplified in FIGS. 9A and 9B, the first tool seat 14 is located in the chuck 20 and the second tool seat 16 is located in the ram 40. In this embodiment, the first tool seat 14 has a sufficient extent in axial direction (sufficient depth) to concentrically support the driven end 55 of the tool even when the tool is retracted from the maximum insertion depth Dₘₐₓ, at which depth the driven portion 54 is fully inserted into the tool passage 12, to a retracted position at which position the tool retaining member 15 still engages the driven portion 54.

The tool retaining arm 24 is formed by a resilient portion of the chuck wall 13 surrounding the axial bore 22. The retaining arm 24 is preferably radially resiliently deflectable for insertion of the driven portion 56 into the bore 22. The retaining arm 24 preferably has a tool engaging tab 25 for contact with the contact surface 60 of the bur 50. The retaining arm is made of a sufficiently strong material (preferably stainless steel) to bias the tool engaging tab 25 against the contact surface 60 with sufficient force, once the driven portion 54 is inserted into the axial bore 22, to frictionally engage the bur 50 for torque transfer and to prevent axial movement of the bur 50 in the drive spindle 10 during operation of the handpiece 100. The selection of appropriate materials for the chuck 20 and the retaining arm 24 is not part of the present invention and is well within the abilities of the art skilled person. It will also be readily apparent to the art skilled person that the chuck 20 may be provided with multiple retaining arms 24, such as the pair of diametrically opposite retaining arms 24 shown in the embodiments of FIGS. 2, 4A and 4B.

In a particularly preferred embodiment, the locking socket 27 extends substantially the whole length of the tool passage 12 for maintaining concentricity during rotation. It is preferable that the locking portion 53 and the locking socket 27 be rotation symmetrical, which means symmetrical about the axis of rotation to prevent excessive vibration of the bur 50 or chuck 20, and thus the handpiece, during high speed rotation. In the alternative, the locking portion 53 and/or the locking socket 27 can also be momentum symmetrical, which means weight balanced about the axis of rotation, again to prevent excessive vibration in the handpiece.

To improve the ease of proper alignment of the locking portion 53 with the locking socket 27, a particularly preferred embodiment of the chuck 20 includes a bur aligning member 53a near the bur insertion end of the drive spindle 10. The bur aligning member 53a preferably corresponds in shape and orientation with the non-circular locking socket 27, which is generally located deep in the drive head of the handpiece. This bur aligning member 53a allows for pre-alignment of the locking portion 53 with the locking socket 27 upon insertion of the driven portion 54 into the drive spindle 10. The bur aligning member 53a forms part of the tool engaging tab 25 in the embodiment shown in FIG. 6.

As shown in FIGS. 2, 4A and 4B, although the chuck 20 and ram 40 are positioned in the spindle 10, the bur 50 is inserted first into the chuck 20 and subsequently enters the axially aligned and adjacent ram 40. In this orientation, the first tool seat 14 is formed in the ram 40 and a portion of the sleeve 30 for supporting the driven end 55 of the tool during length adjustment, and the second tool seat 16 is located in the chuck 20 for supporting the driven portion 54 of the tool at a position between the driven end 55 and the working portion 56.

In the embodiment illustrated in FIG. 2, drive torque is transferred to the sleeve 30 through frictional engagement with the spindle socket 109, for example by press-fitting the spindle 10 into the spindle socket 109. The ram 40 is securely fitted into the spindle and engages the chuck 20 in an orientation wherein lugs 44 extending from the ram 40 toward the chuck 20 engage axial slits 26 formed in the chuck 20. For torque transfer in the embodiment of FIG. 2, as shown in FIGS. 4B and 5, a constricted portion 30a of the casing sleeve 30 provides a locking socket to prevent rotation of the locking portion 53 bur 50 relative to the sleeve 30. The locking socket can be designed in any suitable manner. For instance, as shown in FIG. 5, the constricted portion 30a can have a non-circular cross-section complementary to the non-circular cross-section of the locking portion 53 of the bur 50 or, alternatively, it can provide an interference fit to form a locking socket 27, as described elsewhere above. The constricted portion 30a also prevents rotation of the ram 40, specifically the lugs 44, relative to the sleeve 30. This not only maintains the ram in the same rotational position in the sleeve 30 at all times, but also the chuck 20 due to the interaction between the lugs 44 of the ram 40 and the axial slits 26 in the chuck 20.

In the tool drive arrangement of FIG. 2, as shown in FIGS. 4A and 4B, a tool engaging tab 25 projects from one retaining arm 24, while the second retaining arm 24a has a relatively flattened tab 25a, which essentially acts as a pressure pad against the contact surface 60 of the mechanical indicator 59 of the bur 50 during operation. The pressure pad may be in the form of a flattened tab 25a, as shown, or it may simply be a retaining arm without any tab. A single tab 25 plus pressure pad 25a arrangement, which means an asymmetrical tab arrangement, is preferred for burs 50 which have the mechanical retraction indicator 59 located on the locking portion 53 of the bur 50 (see FIG. 3). In this embodiment, the depth of the detent 51 is asymmetrical about the circumference of the locking portion 53 of the bur 50 due to the non-circular cross-section of the locking portion 53. During operation, the bur 50 is oriented in the spindle 10 such that the tab 25 engages the deeper portion of the detent 51 and the pressure pad 25a engages the shallow portion of the detent 51 where the surface of the bur 50 has been flattened to form the triangular locking portion 53. This orientation is achieved by the specific shape of the locking socket 27 in the sleeve 30 as shown in FIG. 5. The provision of asymmetrical tabs 25 and 25a, as in this embodiment, is especially advantageous for tools with three-sided non-circular locking portions. The use of asymmetrical tabs and a shaped locking socket 27 which forces the bur 50 into the same rotational position relative to the chuck 20 significantly reduces wear. Use of a symmetrical chuck having identical tabs would result in one tab always being in contact with a flattened locking surface on the tool while the other would engage the circular external surface of the tool shaft in the locking portion 56, resulting in wear on that external surface.

A person skilled in the art will appreciate that an asymmetric or single-tab chuck must be counterbalanced to prevent excessive vibration during rotation, in particular at the high rotation speeds encountered with an air turbine handpiece. This can be achieved by balancing the weight of the retaining arms 24 and 24a, or preferably, by balancing the overall spindle system about the central axis for smooth rotation. For example, material can be removed, added, or repositioned in one or more of the sleeve 30, the chuck 20 or the ram 40, to accommodate for any difference in weight between the two retaining arms 24 and 24a, or to balance any other asymmetrical components of the spindle 10. In the embodiment shown in FIGS. 4B and 5, the sleeve has been designed to counterbalance the system due to the asymmetrical design of the chuck. The design of the locking socket 27 is also counterbalanced to prevent vibration during rotation.

In an alternative embodiment to FIG. 2 (not shown), the ram is in torque-receiving communication with the drive mechanism in the handpiece by way of a torque key 28, similar to the torque key 28 on the chuck 20 of the embodiment shown in FIG. 2. The locking socket 27 in this alternate preferred embodiment (not shown) is preferably located within the tool-receiving bore of the ram 40 but may also be located in the sleeve 30, similar to the constricted portion 30a of the sleeve 30 shown in FIG. 4B. The locking socket 27 is preferably elongated and radially supports the bur 50 to maintain concentricity during rotation at various insertion depths between Dₘᵢₙ and Dₘₐₓ.

As shown in FIG. 5, the constricted portion 30 of the sleeve 30 forming the locking socket for torque transfer to the bur 50 has an asymmetrical shape to always align the bur in the socket in the same orientation relative to the sleeve. In particular, the cross-sectional shape of the constricted portion 30a includes a flat portion for engagement with a flattended section on the locking portion 53 of the bur 50, which flat portion is diametrically opposite a circular portion of sufficient diameter to fittingly engage a externally circular section of the locking portion 53. The spacing of the diametrically opposite flat and circular portions of the locking socket in the sleeve 30 (constricted portion 30a) is selected to be substantially equal to the dimensions of the locking portion 53 of the bur 50 so that the locking portion is fittingly insertable into the locking socket and locked against rotation therein for reliable torque transfer from the sleeve 30 to the bur 50.

Other non-circular cross-sectional locking portions and complementary locking sockets are also contemplated, for example, square-, rectangle-, octagonal-, diamond-, star-, and flattened circle-shape among others. A non-circular locking portion can also have a generally circular shape with one or more indents, notches or axial grooves projecting radially inward into the locking portion 53. A variant in which the locking portion 53 of the bur 50 directly engages a locking socket 27 formed in a portion of the drive mechanism, for example a turbine, for direct torque transfer is also contemplated.

It is contemplated that a dental bur in accordance with the present invention can have any type of working tip for contacting a tooth surface known in the art. Furthermore, a portion or all of the tool may be provided with a wear resistant coating. One or more of the components of the rotatable tool drive arrangement of the present invention may be provided with a low friction coating, for example the lugs 44 of the ram 40. It is contemplated that a tool according to the present invention may further comprise an axial channel to allow passage of air or liquid from the handpiece to a surface of a tooth. It is also contemplated that the tool of the invention may be a tool other than a dental bur.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A rotatable dental bur for use in a dental handpiece having spaced apart front and rear bur supports for rotatably supporting the bur and an intermediate friction grip for releasably retaining the bur in the handpiece, the rear bur support being axially elongated to support the bur at different insertion depths from a maximum insertion depth at which the bur is fully inserted into the handpiece to a maximum retraction depth at which the bur is maximally retracted from the rear support, without disengaging from the rear support, the rear support forming a torque lock seat of non-circular cross-section, the bur comprising
a tool body having an axis of rotation, the tool body having a driven portion for insertion into the handpiece and a working portion for projecting from the handpiece during use, the driven portion having a generally cylindrical shape and a torque lock portion for fitting insertion into the rear support at the different insertion depths;
the torque lock portion having an outer circumference for fittingly engaging in the rear support for concentric rotation of the driven end with the rear support, the torque lock portion having at least two planar mantle portions circumferentially spaced apart by intermediate cylindrical mantle portions, for providing the locking portion with a cross-section including alternating circular and straight sections and fitting into the non-circular cross-section of the torque lock seat to prevent rotation of the torque lock portion in the torque lock seat, the circular sections having the same diameter as the outer diameter of the cylindrical shaft, a total area of the planar mantle portions engaged in the rear support when the bur is in the maximum retraction position covering at least 0.001956 square inches, the circular sections extending over at least 30% of the outer circumference of the driven end and the total circumferential angle covered by each planar mantle portion being at least 30°.

2. The tool of claim 1, further comprising a maximum retraction indicator on the driven portion for mechanical engagement with the friction grip of the handpiece for indicating when the bur is retracted from the rear support to the maximum retraction depth to prevent further retraction and disengagement of the driven end from the rear seat.

3. The bur of claim 2, wherein the maximum retraction indicator is located on the torque lock portion of the bur.

4. The bur of claim 2, wherein the maximum retraction indicator is an annular groove extending circumferentially about the torque lock section and across each of the cylindrical mantle portions, each planar mantle portion extends over a first circumferential angle of the tool and each cylindrical mantle portion extends over a second circumferential angle of the tool, with a ratio of the sum of the first angles to the sum of the second angles being 2/3 to 3/2.

5. The bur of claim 4, wherein the torque lock portion of the shaft includes at least 3 cylindrical mantle portions and a plane of the planar mantle portions is oriented parallel to the axis of rotation.

6. The bur of claim 5, wherein the plane is further oriented perpendicular to a radius of the shaft.

7. The bur of claim 6, wherein the cylindrical and planar mantle portions are circumferentially evenly distributed.

8. A bur for use in a dental or medical handpiece having a rotatable chuck with a tool bore for receiving the bur, a friction grip member for frictionally retaining the bur in the chuck and a torque lock seat of non-circular cross-section, the bur comprising
a tool body having an axis of rotation, a working end for projecting from the handpiece and a driven end for insertion into the tool bore of the chuck,
the driven end being a generally cylindrical shaft with a preselected outer circumference for fittingly engaging in the tool bore for concentric rotation of the driven end with the chuck, the shaft including a torque lock portion for fittingly and non-rotatably engaging the torque lock seat of the chuck, the torque lock portion having at least two flat surfaces circumferentially spaced apart by intermediate cylindrical mantle portions, for providing the locking portion with a cross-section including alternating circular and straight sections and fitting into the non-circular cross-section of the torque lock seat to prevent rotation of the torque lock portion in the torque lock seat, the circular sections having the same diameter as the outer diameter of the cylindrical shaft, a total area of the flat surfaces covering at least 0.001956 square inches and the circular sections extending over at least 30% of the outer circumference of the driven end, the circumferential angle covered by each straight section being at least 30°.

9. The tool as defined in claim 8, wherein the locking portion further includes a mechanical stop for mechanical engagement with the grip member.

10. The tool as defined in claim 8, wherein the torque lock portion is axially elongated to allow positioning of the tool in the tool bore at any location from a maximum insertion position wherein the driven end is fully inserted into the chuck to a maximum retraction position wherein only a terminal part of the driven end remains inserted in the chuck but still concentrically supported in the tool bore, the mechanical stop being positioned on the torque lock portion for engagement with the grip member when the tool is in the maximum retraction position and a total area of the flat surfaces on the terminal part covering at least 0.001956 square inches.
